(19) United States
(12) Patent Application Publication
(10) Pub. No.: US 2010/0322448 A1
(43) Pub. Date: Dec. 23, 2010

(54) METHOD FOR OPERATING A HEARING DEVICE AND CORRESPONDING HEARING SYSTEM AND ARRANGEMENT

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Stafa (CH)

(21) Appl. No.: 12/679,695

(22) PCT Filed: Sep. 27, 2007
(86) PCT No.: PCT/EP07/60270

§ 371 Date: Jul. 13, 2010

(51) Int. Cl. H04R 25/00

(52) U.S. Cl. 381/314

(57) ABSTRACT

The method for operating a hearing device (11) comprises the steps of

a) setting a minimum amplification or output level of said hearing device (11);

b) upon receiving a request to reduce an amplification or output level of said hearing device below said minimum amplification or output level: generating an alert and/or preventing the execution of the requested reduction.

Preferably, step a) is carried out upon receiving certain data in said hearing device (11). Such data can be generated by a device (2) installed in an automobile, e.g., a car stereo (2). The minimum amplification or output level can be selectively applied to signals originating from the acoustic environment of a user of the hearing device. A corresponding hearing system (10) and a corresponding arrangement (11) are disclosed, too. In a further aspect, the invention comprises the use of a user control (29) installed in an automobile for controlling at least one functionality of a hearing device (11).

### TECHNICAL FIELD

The invention relates to the field of hearing devices. It relates to methods and apparatuses according to the opening clauses of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

A hearing system comprises at least one hearing device. In case that a hearing system comprises at least one additional device, all devices of the hearing system are operationally connectable within the hearing system. Typically, said additional devices such as another hearing device, a remote control or a remote microphone, are meant to be worn or carried by said individual. Under audio signals we understand electrical signals, analogue and/or digital, which represent sound.

### BACKGROUND OF THE INVENTION

Practically every hearing-aid device comprises a user control for adjusting the amplification or output level of the hearing-aid device, which allows the hearing-aid device user to reduce the perceived sound volume in particularly loud acoustic situations and to increase the perceived sound volume when trying to listen to particularly faint sounds.

In US 2007/0127734 A1, a configurable information distribution system for a vehicle is disclosed. That system can transmit audio signals to hearing aids with a telecoil.

From US 2006/0269088 A1, a multi-coil coupling system for hearing aid applications is known. It is disclosed to transmit audio signals from a car audio via an audio transmission module to a hearing aid.

In US 2003/0152243 A1 it is described to wirelessly transmit audio signals originating from a car stereo to a hearing aid.

U.S. Ser. No. 6,694,034 describes a hearing aid system comprising a first and a second audio source for generating a first and a second audio signal, respectively. Based on an analysis of the second audio signal, at least one of the first and second audio signals are selected for coupling to the hearing aid circuitry.

In WO 2004/034738 A1, a teleloop system is disclosed which comprises two teleloops to be mounted to a neck rest of a car seat, so that a listener wearing hearing aids can receive signals from the teleloop.

It is desirable to provide a new way of operating a hearing device.

### SUMMARY OF THE INVENTION

Therefore, one object of the invention is to provide a new way of operating a hearing device. In addition, a corresponding hearing system and a corresponding arrangement shall be provided.

Another object of the invention is to provide an increased safety of hearing device users in certain situations, in particular when driving an automobile.

Further objects emerge from the description and embodiments below.

At least one of these objects is at least partially achieved by apparatuses and methods according to the patent claims.

The method for operating a hearing device comprises the steps of

a) setting a minimum amplification or output level of said hearing device;
b) upon receiving a request to reduce an amplification or output level of said hearing device below said minimum amplification or output level: generating an alert and/or preventing the execution of the requested reduction.

Through this, a hearing device user can be prevented from perceiving too little of an audible signal.

Said request can be initiated by the hearing device user, e.g., operating a volume control for reducing the output of the hearing device. Or the request can be initiated by a device: e.g., when streaming audio signals to the hearing device, a reduction of the output of the signals received by a hearing device microphone can be requested, so as to achieve a better perception of the streamed audio signals.

Step a) can be carried out upon a specific kind of event. The hearing system comprises
a hearing device; and
a control unit adapted to carrying out the steps of
A) setting a minimum amplification or output level of said hearing device; and
B) upon receiving a request to reduce an amplification or output level of said hearing device below said minimum amplification or output level: generating an alert and/or preventing the execution of the requested reduction.

The arrangement comprises
a hearing system as depicted above; and
a second device operationally connectable to said hearing system;
   wherein said control unit is adapted to carrying out said steps A) and B) upon receiving certain data from said second device.

In one embodiment, said second device comprises or is comprised in a car stereo. The arrangement can comprise said car stereo.

In one embodiment, the method comprises carrying out step a) upon c) receiving certain data in said hearing device.

Such certain data can be, e.g., data indicating that the hearing device is located in a certain location, in particular in a certain acoustic environment.

In one embodiment, said certain data originate from a second device (different from said hearing device). Said second device can be a device of a hearing system to which the hearing device belongs, or a device external to a hearing system to which the hearing device belongs.

In one embodiment, said second device is installed in an automobile. Said second device can be a device to be permanently installed in an automobile.

In one embodiment, said second device comprises or is comprised in a car stereo. In an automobile, there is usually a car stereo provided. It is possible to provide that said second device comprises a wireless interface, e.g., according to the well-known Bluetooth standard, by means of which it can wirelessly transmit data to the hearing device (possibly via another device of the hearing system to which the hearing device belongs). As soon as the hearing device (or a device of the hearing system) is in the communication range of the second device, in particular in the automobile in which the second device is installed, data can be transmitted to the hearing device. The transmitted data can in particular be the before-mentioned certain data, and can indicate that it is time to carry out step a) because of entering an automobile. In an automobile, it is very important that a hearing device user, in particular if the user is the driver, is always able to perceive sounds from his acoustic environment sufficiently loudly. It can be dangerous if the perception of sounds from the acoustic environment is prevented or masked, e.g., by audio signals wirelessly streamed from the car stereo to the hearing device.

Therefore, it can be useful to selectively apply said minimum amplification or output level to signals originating from the acoustic environment of a user of the hearing device.

In one embodiment, said minimum amplification or output level is selected such that a user of said hearing device, when in an automobile, perceives sounds from his acoustic environment sufficiently loudly for ensuring compatibility with road safety requirements.

In one embodiment, said amplification or output level of said hearing device refers to an amplification or output level of signals derived from the acoustic environment of a user of the hearing device.

In one embodiment, the method comprises the step of

d) using at least one user control installed in an automobile for controlling at least one functionality of said hearing device.

When the hearing device/the hearing system is located in an automobile, this can be very useful. E.g., many automobiles today have user controls of the car stereo integrated in the steering wheel, e.g., for adjusting the volume of the car stereo or selecting a new song on a CD in the car audio CD player. It is useful and handy and contributes to the hearing device user's safety to use such user controls for controlling aspects of the hearing device. Said user controls can be permanently installed in the automobile; it can be user controls usually meant for controlling aspects of the before-mentioned second device. If—as it usually will be the case—the hearing device or a hearing system comprising the hearing device comprises a user control for controlling said at least one functionality of said hearing device, the function of the user control of the hearing device can be replaced by said at least one user control installed in an automobile.

Accordingly, in a certain aspect, the invention can comprise an arrangement comprising
a hearing system; and
at least one user control installed in an automobile;
   wherein said user control is operationally connectable to said hearing system, and wherein said hearing system is adapted to enabling a control of at least one functionality of said hearing system using said at least one user control.

And, in the same aspect, the invention can comprise a method for operating a hearing device, comprising using at least one user control installed in an automobile for controlling at least one functionality of said hearing device.

And, also in the same aspect, the invention can comprise a use of a user control installed in an automobile for controlling at least one functionality of a hearing device.

In that aspect of the invention, said at least one user control can be a user control as described above.

The advantages of the hearing systems and arrangements correspond to the advantages of corresponding methods.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a schematic diagram illustrating an arrangement and a method according to the invention;

FIG. 2 a schematic diagram illustrating an arrangement and a method according to the invention.

The reference symbols used in the figures and their meaning are summarized in the list of reference symbols. The described embodiments are meant as examples and shall not confine the invention.

### DETAILED DESCRIPTION OF THE INVENTION

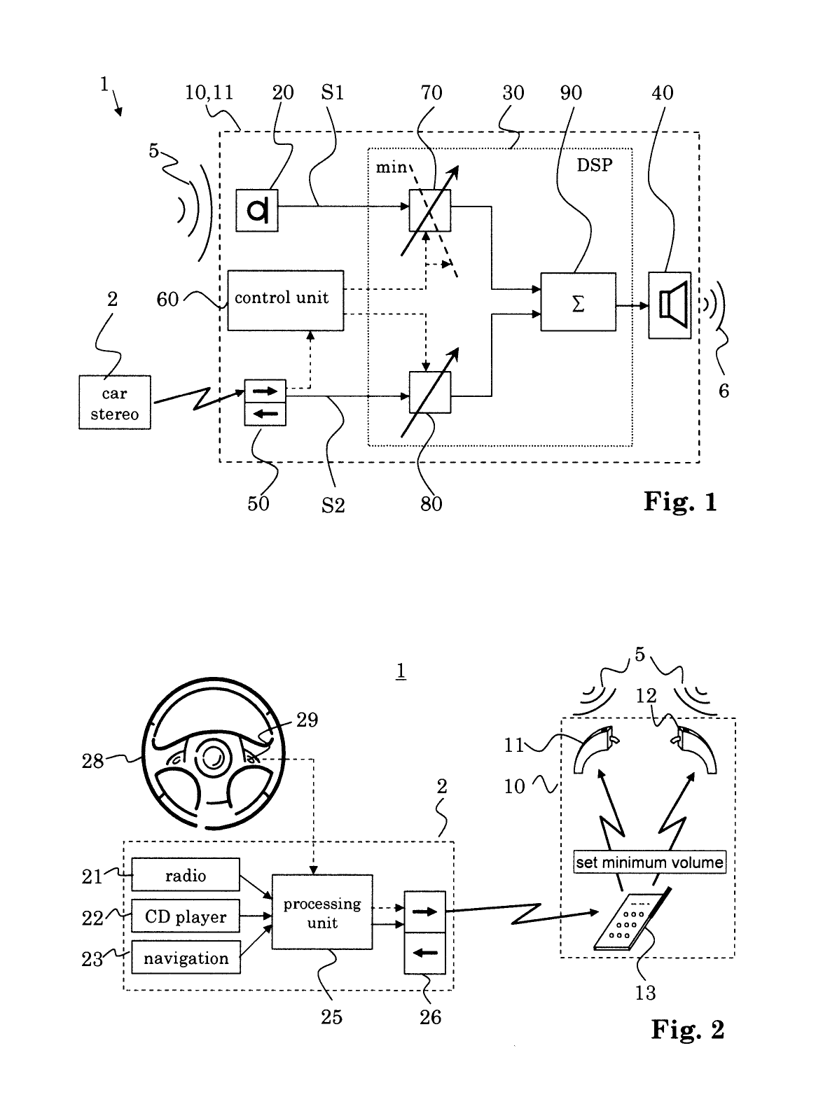

FIG. 1 shows a schematic diagram illustrating an arrangement 1 and a method according to the invention. The arrangement 1 comprises a hearing system 10 and another device 2 operationally connectable to the hearing system 10, wherein in this example, the hearing system 10 is identical with a hearing device 11.

The arrangement 1 comprises an input unit 20 for receiving incoming sound 5 and converting the incoming sound 5 into audio signals S1, an output unit 40 for receiving audio signals and converting these into signals 6 to be perceived by a user of the hearing device 1 and a signal processing unit 30 operationally interconnected between the input unit 20 and the output unit 40 for processing audio signals. The arrangement 1 furthermore comprises a control unit 60 and a receiving or transceiving unit 50, by means of which data can be received, e.g., control signals and/or audio signals, from other devices such as the device 2 embodied as a car stereo 2.

The signal processing unit 30 comprises two level controllers 70,80 and a summing unit 90 and typically many more functional units for advanced audio processing.

The embodiment works as follows: Sound 5 from the environment of the user is converted into audio signals S1 by input unit 20 (e.g., a microphone), which are adjustable in their output level by level controller 70; for example, a user control (such as a toggle) of the hearing system 10 can be used to increase/decrease the amplification or attenuation to which audio signals S1 are subjected (by level controller 70). The resultant audio signals can then be mixed with other audio signals in summing unit 90. The audio signals resulting from the mixing are then converted by output unit 40, e.g., a loudspeaker, into signals to be perceived by the user, e.g., sound waves.

The other audio signals can be received in the hearing device 1, e.g., by means of receiving unit 50, e.g., from car stereo 2 via wireless transmission according to some standard such as Bluetooth. The so-obtained audio signals S2 are adjusted in their level by level controller 80 and then fed to summing unit 90. It is possible to increase the volume determined by level controller 80 and to lower the volume determined by level controller 70 so as to provide the user with less background noise from his (loud) acoustic environment for providing a clearer perception of the streamed audio signals.

Control unit 60 controls the level controller 70 and 80.

Besides audio signals, device 2 can also transmit other data to the hearing device (using the same or a different way of data transmission as for transmitting the audio signals). E.g., as soon as device 2 recognizes that a hearing device 1 is within its communication range, or as soon as the engine of the car is started, device 2 will transmit specific data upon the reception of which the hearing device 1 will take particular actions which are useful when the hearing device user is in an automobile.

Most importantly, control unit 60 will set a minimum value for level controller 70. I.e. it will be impossible to adjust level controller 70 to a value below said minimum value setting. Accordingly, it is assured that—even if requested so by the user or by another device or controller—a reduction of the output level for signals S1 originating from the acoustic environment of the user is lowered below a certain level (said minimum amplification level). This can prevent a reduction of the user's perception of sound from the environment to a level which is incompatible with road safety requirements, in particular if the hearing device user is the driver.

It is additionally or alternatively possible to generate an alert signal when it is attempted to decrease the output level too far. Such an alert signal can be an acoustic signal such as a beep or a voice message (“for your safety, the output volume shall not be lowered any further.”).

In setting a minimum amplification or output level of signals originating from the acoustic environment of a user of the hearing device, it is possible to consider the level set by controller 80 and/or the corresponding amplification or output level of signals originating from audio signals S2. For example, said minimum amplification or output level can be set to a value which is the higher the higher the level of signals derived from audio signals S2 is. It is even possible to set an upper limit for the level of signals derived from audio signals S2 in order to ensure that the user can perceive signals sufficiently well, which originate from the acoustic environment of the user.

FIG. 2 shows a schematic diagram illustrating an arrangement and a method according to the invention, which is compatible with the embodiment of FIG. 1, and differs therefrom in that the hearing system 10 comprises two hearing devices 11,12 and a remote control 13.

The device 2 comprises several audio sources such as a radio 21, a CD player 22 and a navigation system 23, the output of which can be processed/mixed in a processing unit 25. The processing unit 25 also controls, which data are transmitted using the device's transmitting unit 25 (which can be embodied as a transceiving unit 25). The transmitting unit 25 furthermore receives control signals from a user control 29, which can be installed in the automobile's steering wheel 28.

Upon a certain event, data are transmitted from device 2 to the hearing system 10, upon the reception and evaluation of which in the remote control 13, the hearing devices 11,12 (wirelessly interconnected with remote control 13) will be controlled such that a minimum output level is set, as has been discussed before.

Furthermore, it is possible to use user control 29 for controlling one or more functionalities of the hearing system 10, such as increasing or decreasing the output volume or selecting a hearing program. For this, device 2 and the hearing system 10 have to be programmed accordingly.

### LIST OF REFERENCE SYMBOLS

1 arrangement
2 device, car stereo
5 incoming sound, acoustic waves from the environment
6 signals to be perceived by the user, output sound, sound waves
10 hearing system
11 hearing device
12 hearing device
13 remote control
20 input unit, acoustic-electric converter unit, microphone arrangement
21 audio source, radio
22 audio source, CD player
23 audio source, navigation system audio output
25 processing unit
26 transmitting unit, transceiving unit, transceiver
28 steering wheel
29 user control, toggle, slider
30 signal processing unit, digital signal processor, DSP
40 output unit, electric-acoustic converter unit, loudspeaker
50 receiving unit, transceiving unit, transceiver
60 control unit, controller
70 level controller, volume adjuster
80 level controller, volume adjuster
90 adder, summing unit
S1, S2 audio signals

What is claimed is:

1. A method for operating a hearing device, comprising the steps of
a) setting a minimum amplification or output level of said hearing device;
b) upon receiving a request to reduce an amplification or output level of said hearing device below said minimum amplification or output level: generating an alert and/or preventing the execution of the requested reduction.

2. The method according to claim 1, comprising carrying out step a) upon
c) receiving certain data in said hearing device.

3. The method according to claim 2, wherein said certain data originate from a second device.

4. The method according to claim 3, wherein said second device is installed in an automobile.

5. The method according to claim 3, wherein said second device comprises or is comprised in a car stereo.

6. The method according to claim 1, wherein said minimum amplification or output level is selected such that a user of said hearing device, when in an automobile, perceives sounds from his acoustic environment sufficiently loud for ensuring compatibility with road safety requirements.

7. The method according to claim 1, wherein said amplification or output level of said hearing device refers to amplification or output level of signals derived from the acoustic environment of a user of the hearing device.

8. The method according to claim 1, comprising the step of
d) using at least one user control installed in an automobile for controlling at least one functionality of said hearing device.

9. A hearing system comprising
a hearing device; and
a control unit adapted to carrying out the steps of
A) setting a minimum amplification or output level of said hearing device; and
B) upon receiving a request to reduce an amplification or output level of said hearing device below said minimum amplification or output level: generating an alert and/or preventing the execution of the requested reduction.

10. The hearing system according to claim 9, wherein said minimum amplification or output level is selected such that a user of said hearing device, when in an automobile, perceives sounds from his acoustic environment sufficiently loud for ensuring compatibility with road safety requirements.

11. An arrangement comprising
the hearing system according to claim 9;
a second device operationally connectable to said hearing system; wherein said control unit is adapted to carrying out said steps A) and B) upon receiving certain data from said second device.

12. The arrangement according to claim 11, wherein said second device is installed in an automobile.

13. The arrangement according to claim 11, wherein said second device comprises or is comprised in a car stereo.

14. The arrangement according to claim 11, comprising at least one user control installed in an automobile, which is operationally connectable to said hearing system, and wherein said hearing system is adapted to enabling a control of at least one functionality of said hearing system using said at least one user control.

15. An arrangement, comprising a hearing system and at least one user control installed in an automobile, wherein said user control is operationally connectable to said hearing system, and wherein said hearing system is adapted to enabling a control of at least one functionality of said hearing system using said at least one user control.

16. A method for operating a hearing device, comprising using at least one user control installed in an automobile for controlling at least one functionality of said hearing device.

17. Use of a user control installed in an automobile for
controlling at least one functionality of a hearing device.
